(19) United States
(12) Patent Application Publication
(10) Pub. No.: US 2026/0218827 A1
(43) Pub. Date: Jul. 30, 2026

(54) QUICK CHANGE CAP ADAPTOR MANIFOLD

(71) Applicant: FCA US LLC, Auburn Hills, MI (US)

(72) Inventors: Elias H. Bassil, Auburn Hills, MI (US); Jeffery Beach, Auburn Hills, MI (US); Michael Koltuniak, Auburn Hills, MI (US)

(21) Appl. No.: 19/036,690

(22) Filed: Jan. 24, 2025

(51) Int. Cl. F16L 37/24; B23K 11/30

(52) U.S. Cl. CPC F16L 37/24; B23K 11/3018

(57) ABSTRACT

A welding gun cap adaptor manifold has a block body. A first and second bore are the body. The bores are parallel to one another. A third bore extends into the body such that the third bore is in communication with the first and second bores to provide a path through the manifold. The third bore has a diameter to receive a cap adaptor end. A fourth bore is transverse to the third bore in the block. The fourth bore receives a pin to lock the cap adaptor in the block.

### FIELD

The present disclosure relates to weld guns utilized during automotive manufacturing.

### BACKGROUND

This section provides background information related to the present disclosure which is not necessarily prior art.

Weld guns used in automotive manufacturing include a cap adaptor that applies a spark during welding. These cap adaptors include a tip that degenerates during the manufacturing process. Thus, the cap adaptor requires replacement after its useful lifetime and another cap adaptor is inserted into the weld gun arm. Previous solution caused additional maintenance labor to replace the cap adaptor.

Particularly, with internal connection of the water lines have a limited access to release the lines from the fitting. Disconnecting of the two water lines internally requires a wrench to compress the fitting clamp and then the line is removed with needle nose pliers to pull the lines free before the cap adaptor can be removed from the arm. Thus, the first and second water lines must be disconnected before the cap adaptor can be pulled away from the weld arm. This causes the maintenance labor, during replacement of the worn cap adaptor, to be 45 minutes or so to replace the cap adaptor. Also, there is a risk of inverting the lines during reinstallation of the cap adaptor. Thus, there is a desire in the field to eliminate this type of individual attaching of the water lines to the manifold during the replacement of the cap adaptor.

Accordingly, the present disclosure provides a manifold that enables the elimination of removing the individual water lines during disassembly and reinstallation of the cap adaptor. Additionally, the present disclosure reduces the maintenance and labor time to remove the weld cap adaptor to about 15 minutes. The present disclosure also eliminates the opportunity for error when reconnecting the water lines as in the prior art water manifold. The present design utilizes a manifold that maintains connection with the original water lines during disconnection of the cap adaptor. The present disclosure enables the cap adaptor to be push fit into a water manifold and locked into position in the manifold. Thus, the main manifold is retained in the weld gun arm and the used cap adaptor is removed and a new cap adaptor is reinserted into the manifold.

### SUMMARY

This section provides a general summary of the disclosure, and is not a comprehensive disclosure of its full scope or all of its features.

According to a first aspect of the disclosure, a weld gun cap adaptor manifold comprises a block body with a first and second bore. The bores are parallel to one another. A third bore extends into the body. The third bore is in communication with the first and second bores to provide a path through the manifold. The third bore has a diameter to receive a cap adaptor end. A fourth bore is transversed to the third bore. The fourth bore receives a pin to lock the cap adaptor in the block. A first and second coupling are received in the first and second bores. The couplings receive a water inlet line and a water outlet line. The third bore has a first diameter to receive the cap adaptor and a second smaller diameter in communication with the first and second bores. A conduit extends from the first bore smaller diameter for entrance into the cap adaptor for delivering the cooling water. The first and second bores include threads to receive the coupling. Also, the body may include a nipple that includes the third bore.

According to a second aspect of the disclosure, a welding gun comprises a housing to receive fluid lines and a bore to receive a cap adaptor. A manifold is positioned in the bore to couple with the cap adaptor. The manifold comprises a block body with a first and second bore. The bores are parallel to one another. A third bore extends into the body. The third bore is in communication with the first and second bores to provide a path through the manifold. The third bore has a diameter to receive a cap adaptor end. A fourth bore is transversed to the third bore. The fourth bore receives a pin to lock the cap adaptor in the block. A first and second coupling are received in the first and second bores. The couplings receive a water inlet line and a water outlet line. The third bore has a first diameter to receive the cap adaptor and a second smaller diameter in communication with the first and second bores. A conduit extends from the first bore smaller diameter for entrance into the cap adaptor for delivering the cooling water. The first and second bores include threads to receive the coupling. Also, the body may include a nipple that includes the third bore.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a weld gun arm.

FIG. 2 is a partial cross-section view of the arm of FIG. 1.

FIG. 3 is a partial cross-section view of the arm with the cap adaptor removed.

FIG. 4 is a cross-section view of FIG. 3.

FIG. 5 is a second embodiment of the manifold.

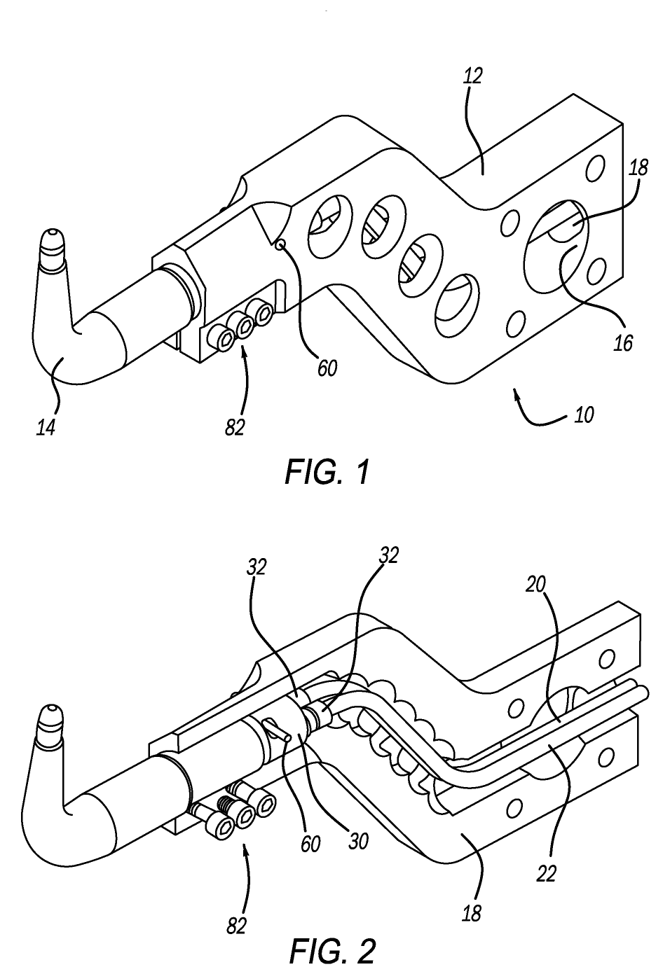

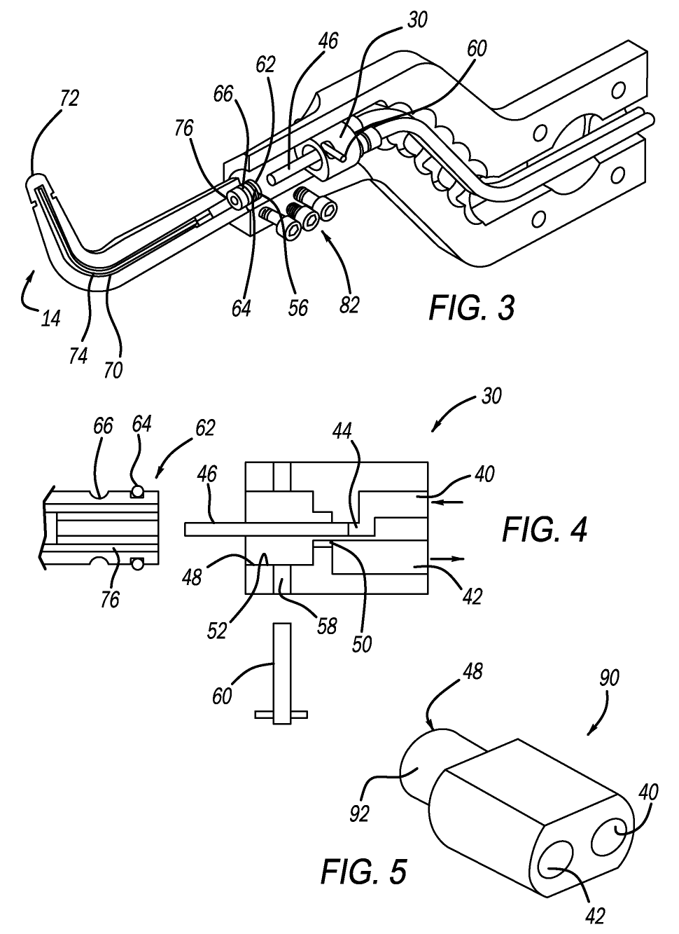

Corresponding reference numerals indicate corresponding parts throughout the several views of the drawings.

### DETAILED DESCRIPTION

Example embodiments will now be described more fully with reference to the accompanying drawings.

Turning to the figures, a weld gun arm assembly is designated with the reference numeral 10. The arm assembly 10 includes an arm 12 and a cap adaptor 14. The arm 12 includes a plurality of apertures or bores 16 that enable access inside of the arm 12. Additionally, the arm includes a through bore 18 that extends through the arm 12 from one end to the other. The bores 16 are generally transverse to the channel or bore 18. Inlet water line 20 and an outlet water line 22 are positioned in the bore 18 to enable the cooling fluid or water to enter into and exit the cap adaptor 14. A water manifold assembly 30 connects with the water inlet and outlet lines 20, 22. Couplings 32 secure the water lines 20, 22 with the water manifold 30. The couplings 32 are generally threaded couplings that thread into the manifold assembly 30. The couplings 32 then receive the water lines 20, 22 to maintain them on the manifold assembly 30.

The manifold assembly 30 includes a first bore 40 and a second bore 42. The bores 40, 42 are parallel with one another and receive the couplings 32 to attach the water lines 20, 22 with the manifold assembly 30. The first bore 40 includes a smaller diameter portion 44 that receives a conduit 46. The conduit 46 delivers the cooling water to the cap adaptor 14. The manifold 30 includes a third bore 48. The third bore 48 terminates at the bore 42 to return the used water to the outlet line 22. The third bore 48 includes a smaller diameter portion 50 at its terminus to enable passage of the conduit 46. The large portion 52 has a diameter that receives the coupling 56 of the cap adaptor 14.

The manifold block 30 also includes a fourth bore 58. The fourth bore 58 is transverse to the third bore 48. The fourth bore 58 receives a pin 60 that retains and secures the cap adaptor to the manifold 30. The coupling 56 includes a nipple portion 62 that receives a sealing O-ring 64. Additionally, there is a groove 66 toward the cap adaptor 14. The groove 66 receives a portion of the pin 60 to retain the cap adaptor in the manifold block 30.

The cap adaptor 14 includes a channel or conduit 70 that receives conduit 46 from the manifold 30. The conduit 70 terminates at the tip 72 of the cap adaptor 14. An outlet channel 74 surrounds the conduit 70. As liquid exits the conduit 70, it is received in the channel 74.

The channel 74 passes around the conduit 70 so that it enters into the nipple 62 via bore 76. The bore 76 is through the nipple 62 and surrounds the conduit 46. The bore 76 empties into the third bore 48 thus enabling the water to exit into the second bore 42.

In operation, the water enters through the inlet line 20 into the manifold block 30. It passes through the bore 40 through smaller diameter bore portion 42 into the conduit 46. With the coupling 62 attached, the conduit 42 expels the water into the conduit 70. The water in the conduit 70 passes to the tip 72 of the cap adaptor 14. After the water exits the conduit 70, it is recovered in the channel 74. The channel 74 passes through the cap adaptor 14 into the coupling 62 where the bore of the coupling 62 is larger than the conduit 46 to enable the water to pass back into the manifold block 30. The water is passed into the smaller diameter portion 50 of the third conduit bore 48. The third conduit bore 48 is coupled with the second bore 42 to enable the fluid to exit into the water line 22. The pin 60 retains the cap adaptor 14 within the manifold 30 by positioning into the groove 66 to lock the cap adaptor 14 in position.

Thus, the manifold block 30 is positioned in the bore 18 and remains in the bore 18 during removal and attachment of the cap adaptors 14. Thus, the screws 82 are removed from weld gun enabling the nose portion to be exposed. As this occurs, the pin 60 is in the weld gun arm is withdrawn. Thus, due to the bolts being loosened, the cap adaptor 14 can be removed from the weld gun arm 12. The bolts 82 or screws provide a clamping effect on the cap adaptor 14 when they are tightened.

Thus, upon removal or loosening of the bolts and removal of the pin 60, the cap adaptor 14 can be pulled out of the weld gun 14. Likewise, when a new cap adaptor 14 is inserted, it can be pushed into the bore 18 and secured by the pin 60. After this happens, the screws 82 are again tightened clamping the cap adaptor 14 in the weld gun arm 12 to provide additional securement of the cap adaptor 14 in the weld gun arm 12.

Turning to FIG. 5, a second embodiment of the manifold 90 is illustrated. Here, the block 90 is substantially the same as that previously discussed except an extending nipple 92 projects from the block 90 that include the third bore 48. Accordingly, the same numerals will be utilized to identify the same features. The block 90 functions in the same way as that previously discussed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A welding gun cap adaptor manifold comprising:
a block body;
a first and second bore in the block, the bores are parallel to one another;
a third bore is formed in the block, the third bore extending into the body such that the third bore is in communication with the first and second bores providing a path through the manifold, the third bore having a diameter to receive a cap adaptor end; and
a fourth bore, transverse to the third bore, in the block, the fourth bore receiving a pin for locking the cap adaptor in the block.

2. The welding gun cap adaptor manifold of claim 1, wherein a first and second coupling are received in the first and second bores, the coupling receiving a water inlet line and a water outlet line.

3. The welding gun cap adaptor manifold of claim 1, wherein the third bore has a first diameter for receiving the cap adaptor and a second smaller diameter communicating the first and second bores.

4. The welding gun cap adaptor manifold of claim 3, wherein a conduit extends from the first bore smaller diameter for entrance into the cap adaptor.

5. The welding gun cap adaptor manifold of claim 1, wherein the first and second bores include threads for receiving couplings.

6. The welding gun cap adaptor manifold of claim 1, wherein the block body includes a nipple.

7. A welding gun comprising:
a housing for receiving fluid lines and a bore for receiving a cap adapter and a manifold in the bore for coupling with the cap adaptor, the manifold comprising:
a block body;
a first and second bore in the block body, the bores are parallel to one another;
a third bore is formed in the block, the third bore extending into the body such that the third bore is in communication with the first and second bores providing a path through the manifold, the third bore having a diameter to receive a cap adaptor end; and
a fourth bore, transverse to the third bore, in the block, the fourth bore receiving a pin for locking the cap adaptor in the block.

8. The welding gun of claim 7, wherein a first and second coupling are received in the first and second bores, the coupling receiving a water inlet line and a water outlet line.

9. The welding gun of claim 7, wherein the third bore has a first diameter for receiving the cap adaptor and a second smaller diameter communicating the first and second bores.

1010 The welding gun of claim 9, wherein a conduit extends from the first bore smaller diameter for entrance into the cap adaptor.

11. The welding gun of claim 7, wherein the first and second bores include threads for receiving couplings.

12. The welding gun cap adaptor manifold of claim 7, wherein the block body includes a nipple.
